(19) United States
(12) Patent Application Publication
(10) Pub. No.: US 2014/0340358 A1
(43) Pub. Date: Nov. 20, 2014

(54) METHOD FOR IMPROVING AN INTERACTION WITH A USER INTERFACE DISPLAYED ON A 3D TOUCH SCREEN DISPLAY

(71) Applicant: EXO U INC., Montréal (CA)

(72) Inventor: Jean-Baptiste Martinoli, Montreal (CA)

(21) Appl. No.: 14/363,806

(22) PCT Filed: Nov. 30, 2012
(86) PCT No.: PCT/CA2012/001102

§ 371 Date: Jun. 8, 2014

Related U.S. Application Data
(60) Provisional application No. 61/568,503, filed on Dec. 8, 2011.

(51) Int. Cl. G06F 3/0488; G06T 15/08; G06F 3/044

(52) U.S. Cl. CPC G06F 3/04886; G06F 3/044; G06T 15/08; G06F 2203/04101; G06T 2200/04
USPC 345/174

(57) ABSTRACT

A method is disclosed for improving an interaction with a user interface displayed on a 3D touch screen display, the method comprising detecting an event, in response to the detection of the event, displaying the user interface comprising at least one depressible button using the 3D display such that the depressible button appears to be to the user in front of the surface of the 3D touch screen display to thereby reduce a pressure made by a user on the surface of the 3D touch screen display when the user interacts with the depressible button.

### CROSS-REFERENCE TO RELATED APPLICATIONS

This patent application is a 35 USC 371 national phase application of PCT/CA2012/001102 filed on Nov. 30, 2012, which claims priority on U.S. Provisional Patent Application No. 61/568,503, entitled “Method for Improving an Interaction for a User Interface, Displayed on a 3D Touch Screen Display,” filed on Dec. 8, 2011, the specifications of which are herein incorporated by reference.

### FIELD OF THE INVENTION

The invention relates to the field of computing devices. More precisely, this invention pertains to a method for improving an interaction with a user interface displayed on a 3D touch screen display.

### BACKGROUND

Touch screen displays are now widely used. For instance touch screen displays may be used in tablet computers, in smartphones, etc.

Unfortunately, there are some drawbacks associated with the user of the touch screen displays in the case of specific software applications.

For instance, in the case of software applications in which a lot of physical interactions is required such as in the case of word processing application which require a lot of typing, the user may feel some pain in its fingers due to the nature of the multiple interactions of its fingers with the surface of the touch screen display. As result, the user may have to operatively connect a keyboard to the touch screen display to reduce the fatigue. Such solution is cumbersome.

There is therefore a need for a method that will overcome at least one of the above-identified drawbacks.

Features of the invention will be apparent from review of the disclosure, drawings and description of the invention below.

### BRIEF SUMMARY

According to a broad aspect of the invention, there is provided a method for improving an interaction with a user interface displayed on a 3D touch screen display, the method comprising detecting an event, in response to the detection of the event, displaying the user interface comprising at least one depressible button using the 3D touch screen display such that the depressible button appears to be to the user in front of the surface of the 3D touch screen display to thereby reduce a pressure made by a user on the surface of the 3D touch screen display when the user interacts with the depressible button.

According to one embodiment, the event comprises one of providing a key character to an application, launching a program, executing a file, launching a portion of an application and accessing a weblink.

According to one embodiment, the depressible button comprises at least one of a letter, a number, a character, a symbol, a picture, an animation and a video.

According to another broad aspect, there is provided a computing device, the computing device comprising a 3D touch screen display; a central processing unit; a memory comprising a program, wherein the program is stored in the memory and configured to be executed by the central processing unit, the programs comprising instructions for detecting an event; instructions for displaying the user interface, in response to the detection of the event, the displaying of the user interface comprising at least one depressible button using the 3D touch screen display such that the depressible button appears to be to the user in front of the surface of the 3D touch screen display to thereby reduce a pressure made by a user on the surface of the 3D touch screen display when the user interacts with the depressible button.

According to another broad aspect of the invention, there is provided a computer-readable storage medium storing computer-executable instructions which, when executed, cause a computing device comprising a 3D touch screen display to perform a method for improving an interaction with a user interface, the method comprising detecting an event; in response to the detection of the event, displaying the user interface comprising at least one depressible button using the 3D touch screen display such that the depressible button appears to be to the user in front of the surface of the 3D touch screen display to thereby reduce a pressure made by a user on the surface of the 3D touch screen display when the user interacts with the depressible button.

An advantage of the method disclosed is that a user may end up applying less pressure on the 3D touch screen display when interacting with the user interface disclosed herein than with a prior art user interface.

A resulting advantage of the method disclosed is that a user may feel less pain originating from multiple contacts with the surface of the 3D touch screen display when interacting with the method disclosed herein than with a prior art method for interacting with a touch screen display.

A resulting advantage of the method disclosed is that a user may interact with the user interface disclosed for a longer period than with a prior art user interface displayed on a touch screen display.

Another advantage of the method disclosed is that it is possible with the method disclosed to get more attraction or interest for specific element of the user interface by overlapping them more than others.

### BRIEF DESCRIPTION OF THE DRAWINGS

In order that the invention may be readily understood, embodiments of the invention are illustrated by way of example in the accompanying drawings.

FIG. 1 is a flowchart which shows an embodiment of a method for improving an interaction with a user interface displayed on a 3D touch screen display.

FIG. 2a is a schematic which shows a first step of an interaction of a finger of a user with a 3D touch screen display wherein the finger of the user has not reached what is believed to be the user interface by the brain of the user.

FIG. 2b is a schematic which shows a second step of an interaction of a finger of a user with the 3D touch screen display wherein the finger has reached what is believed to be the user interface by the brain of the user.

FIG. 2c is a schematic show shows a third step of an interaction of a finger of a user with the 3D touch screen display wherein the finger has reached the surface of the 3D touch screen display and is now in contact with the surface.

FIG. 3 is a block diagram which shows a processing device in which an embodiment of the method for improving an interaction with a user interface displayed on a 3D touch screen display may be implemented.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

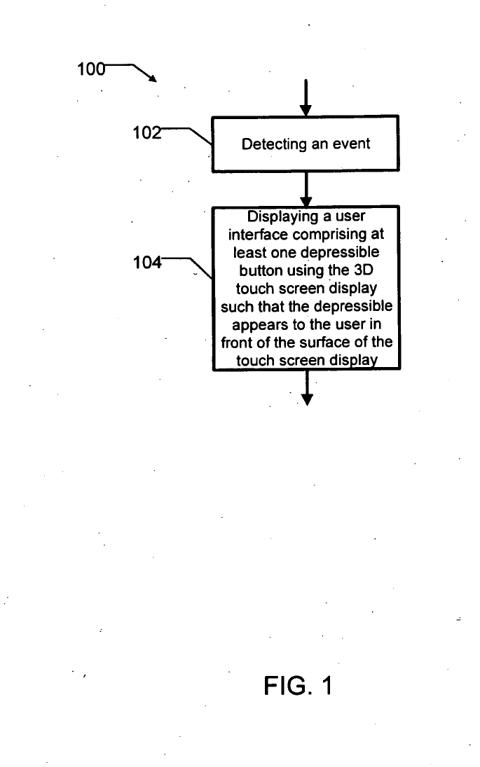

Now referring to FIG. 1, there is shown an embodiment of a method for improving an interaction with a user interface displayed on a 3D touch screen display.

According to processing step 102 an event is detected.

It will be appreciated that the event may be of various types. For instance, the event may be to provide a key character to an active application as for a regular keyboard, for instance a word processing program. It can also be the launch of a program or a file (shortcut) or a weblink. Alternatively, the event may be the launching of a portion of an application. More generally, it will be appreciated that the event may be any event associated with a request to display or amend the display of at least one depressible button.

According to processing step 104, a user interface is displayed in response to the event. The user interface comprises at least one depressible button.

It will be appreciated that the depressible button may be of various types. In fact, the depressible button may comprise at least one of a letter, a number, a character, a symbol, a picture, an animation and a video.

More precisely, the user interface displayed comprises at least one depressible button. The at least one depressible button is displayed using the 3D stereoscopic touch screen display. More precisely, the at least one depressible button is displayed using the 3D touch screen display such that the at least one depressible button appears to be to the user in front of the surface of the 3D touch screen display.

It has been contemplated that performing such displaying of the user interface results subsequently in a user hitting the surface of the 3D touch screen display with less pressure than with the prior art display of the user interface on the 3D touch screen display. This is due to the fact that the brain of the user is tricked and considers that the user interface has already been touched by the finger. The user will therefore believe that the contact with the user interface has already occurred when it has not which is of great advantage as explained further below.

In fact and as a consequence, less movement will be then applied by the user to its finger. This will result in less pressure being applied by the finger on the surface when finally hitting the surface of the 3D touch screen display.

Since the surface of the 3D touch screen display may be made of glass, less pressure applied by the finger on the surface will result in less pain for the user.

As a result, interacting with a keyboard displayed on the 3D touch screen surface will be more enjoyable and therefore more attractive.

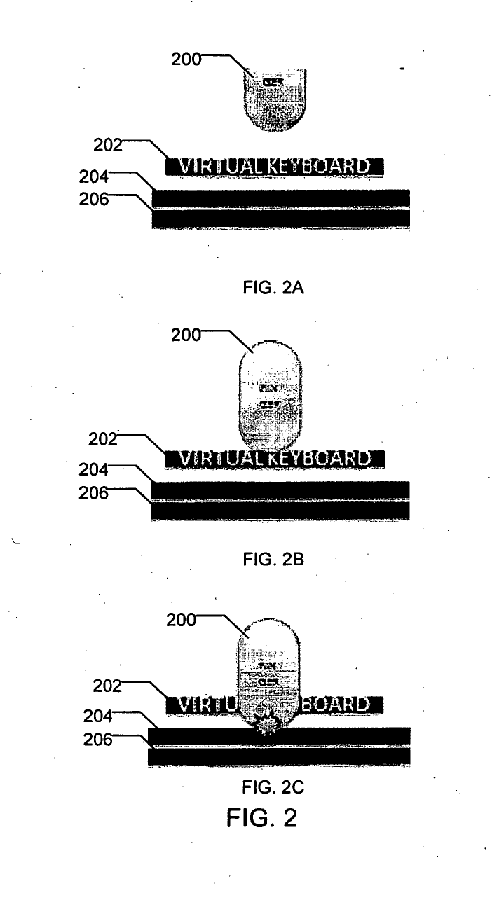

Now referring to FIG. 2A, there is shown a first step of an interaction of a finger 200 of a user with a 3D touch screen display wherein the finger 200 of the user has not reached what is believed to be the user interface 202 by the brain of the user. As mentioned above, the user interface 202 comprises at least one depressible button. As shown, the touch screen display comprises a touch sensor panel 204 and a display screen 206.

FIG. 2B shows a second step of an interaction of the finger 200 of the user with the 3D touch screen display. In this embodiment, the finger 200 has reached what is believed to be the user interface 202 by the brain of the user. The user interface 202 is displayed such as it appears to be in front of the surface of the 3D touch screen display 202.

Now referring to FIG. 2C, there is shown a third step of an interaction of the finger 200 of the user with the 3D touch screen display wherein the finger 200 has reached the surface of the 3D touch screen display and is now in contact with the touch sensor panel 204 of the 3D touch screen display 202.

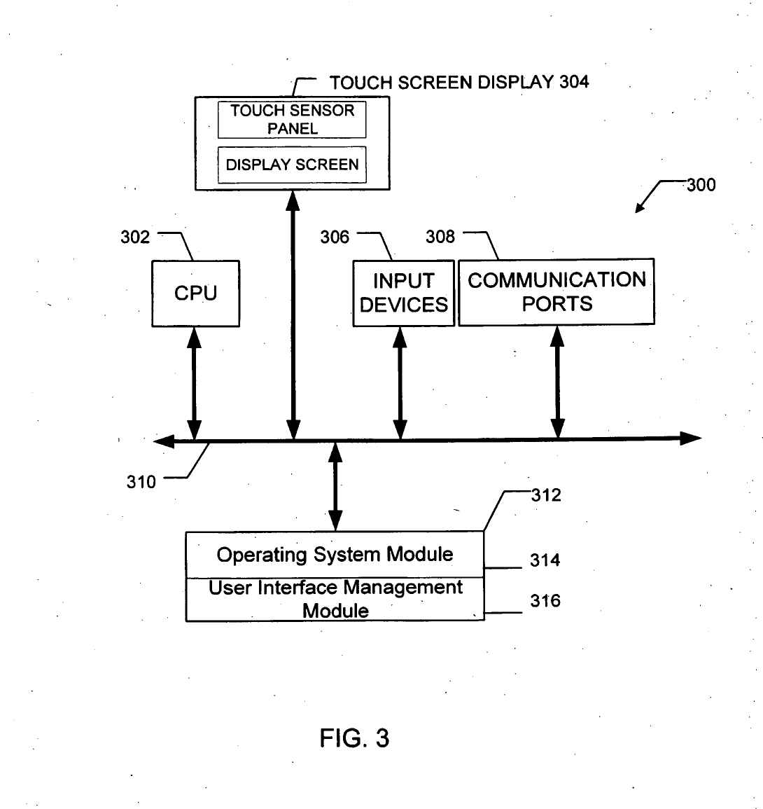

Now referring to FIG. 3, there is shown an embodiment of a processing device 300 in which a method for improving an interaction with a user interface displayed on a 3D touch screen display may be implemented.

Still referring to FIG. 3 and in accordance with one embodiment, the processing device 300 comprises a Central Processing Unit (CPU) 302, a 3D touch screen display 304, input devices 306, communication ports 308, a data bus 310 and a memory 312.

The Central Processing Unit 302, the 3D touch screen display 304, the input devices 306, the communication ports 308 and the memory 312 are connected together using the data bus 410.

In one embodiment the Central Processing Unit 302 is an 17 processor with GPU GMA 2000 which is manufactured by Intel™ and which is running at 2.4 GHz and is supporting 64 bits.

Still in this embodiment, the 3D touch screen display 312 comprises a touch sensor panel 204 having a diagonal screen size of 40 inches and a resolution of 1920×1080 pixels. It is based on the technology of the 3M™ C3266PW chassis.

The touch sensor panel 204 uses in this embodiment an infrared technology known to the ones skilled in the art. The touch sensor panel 204 is operatively connected to a controller, not shown, using a universal serial bus (USB) port.

In an earlier embodiment, a 3M™ projected capacitive touch panel having a diagonal screen size of 32 inches was used as a prototype.

The 3D touch screen display 304 further comprises a display screen 206 placed below the touch sensor panel 204. The display screen 206 has a diagonal screen size of 40 inches and is a standard 3D LED LCD 1080p screen. More precisely and in a preferred embodiment, the 3D touch screen display is Sony™ Bravia HX800 series 3D HDTV which has a viewing angle of 178 degrees, a 240 Hz refresh rate and which offers 3D stereoscopic with 3D glasses.

The display screen 206 is operatively connected to the Central Processing Unit (CPU) 302 via an HDMI connector. The skilled addressee will appreciate that for sake of clarity the controller of the 3D touch screen display 304 has not been shown in FIG. 3.

It will be appreciated that the method disclosed herein may be implemented with 3D technologies in which 3D glasses are worn by the user. Alternatively, the method disclosed may be implemented using 3D technologies in which the user does not need to wear 3D glasses, such as technologies based on the parallax barrier or lenticular lens technology.

In one embodiment, the operator must wear a pair of 3D glasses in order to view 3D. Alternatively, the method may be implemented with a parallax LCD panel having a width of 7 inches and further having a capacitive touch panel having a width of 7 inches for the touch input. It will be appreciated that in this embodiment the user does not have to wear 3D glasses.

The input devices 306 are used for providing data to the apparatus 300.

The skilled addressee will appreciate that various alternative embodiments may alternatively be provided for the input devices 306.

The communications ports 308 are used for enabling a communication of the apparatus 300.

In one embodiment, the communication ports 308 comprise a WIFI 802.11 b/g/n port, a Bluetooth 2.1+EDR port, two USB 2.0 ports, a SD/SDHC card reader, a mini HDMI port, and an audio 5.1 port. The skilled addressee will again appreciate that various other alternative embodiments may be provided for the communication ports 308.

Still referring to FIG. 3 and in accordance with one embodiment, the memory 312 is used for storing data.

In this embodiment, the memory 312 comprises DDR3 SDRAM and has a size of 4 GB.

More precisely and still in this embodiment, the memory 312 comprises, inter alia, an operating system module 314. The operating system module 314 is Windows 7™ Home Premium Edition manufactured by Microsoft™.

The memory 312 further comprises a user interface management module 316. The user interface management module 316 is used for managing the interface displayed on the touch screen display 304.

In one embodiment, the user interface is implemented using HTML 5. The user interface is displayed in an HTML text area. As mentioned previously, the user interface comprises at least one depressible button.

Still in accordance with a preferred embodiment, it will be appreciated that the user interface generated using two offsets images that are then combined in the brain of the user in order to give the perception of 3D depth.

It will be appreciated that each offset image is visible by one of the two eyes.

In the embodiment wherein parallax barrier technology is used, each eye will see only a respective offset image of the two offset images for its side.

In the embodiment wherein 3D glasses are used, the user interface displayed in each of the two offset images (i.e. the left offset image for the left eye and the right offset image for the right eye) is shifted a bit.

More precisely, the user interface is shifted a bit on the left in the right offset image and the user interface is shifted a bit one the right in the left offset image such as a distance comprised between 0.5 cm to 2 cm is perceived by the user between the user interface and the surface of the 3D touch screen display.

In one embodiment, the distance is 0.8 cm.

In one embodiment, the user will have access to a setting menu and will be able to setup the distance (or depth) from the user interface keyboard to the surface of the 3D touch screen display.

It will be appreciated that the method for improving an interaction with a user interface displayed on a 3D touch screen display may be implemented within the user interface management module 316.

In such embodiment, the user interface management module 316 comprises instructions for detecting an event.

The user interface display 316 further comprises instructions for displaying the user interface comprising at least one depressible button using the 3D touch screen display such that the depressible button appears to be to the user in front of the surface of the 3D touch screen display in response to the detection of the event.

It will be appreciated by the skilled addressee that alternative embodiments may be possible. For instance, the method for improving an interaction with a user interface displayed on a 3D touch screen display may be implemented within the operating system module 114.

Although the above description relates to a specific preferred embodiment as presently contemplated by the inventor, it will be understood that the invention in its broad aspect includes mechanical and functional equivalents of the elements described herein.

Clause 1: A method for improving an interaction with a user interface displayed on a 3D touch screen display, the method comprising:

detecting an event,

in response to the detection of the event, displaying the user interface comprising at least one depressible button using the 3D touch screen display such that the depressible button appears to be to the user in front of the surface of the 3D touch screen display to thereby reduce a pressure made by a user on the surface of the 3D touch screen display when the user interacts with the depressible button.

Clause 2: The method as claimed in clause 1, wherein the event comprises one of providing a key character to an application, launching a program, executing a file, launching a portion of an application and accessing a weblink.

Clause 3: The method as claimed in any one of clauses 1 to 2, wherein the depressible button comprises at least one of a letter, a number, a character, a symbol, a picture, an animation and a video.

Clause 4: A computing device, the computing device comprising:

a 3D touch screen display;

a central processing unit;

a memory comprising a program, wherein the program is stored in the memory and configured to be executed by the central processing unit, the programs comprising:
instructions for detecting an event;
instructions for displaying the user interface, in response to the detection of the event, the displaying of the user interface comprising at least one depressible button using the 3D touch screen display such that the depressible button appears to be to the user in front of the surface of the 3D touch screen display to thereby reduce a pressure made by a user on the surface of the 3D touch screen display when the user interacts with the depressible button.

Clause 5: A computer-readable storage medium storing computer-executable instructions which, when executed, cause a computing device comprising a 3D touch screen display to perform a method for improving an interaction with a user interface, the method comprising:
detecting an event;
in response to the detection of the event, displaying the user interface comprising at least one depressible button using the 3D touch screen display such that the depressible button appears to be to the user in front of the surface of the 3D touch screen display to thereby reduce a pressure made by a user on the surface of the 3D touch screen display when the user interacts with the depressible button.

1. A method for improving an interaction with a user interface displayed on a 3D touch screen display, the method comprising:
detecting an event,
in response to the detection of the event, displaying the user interface comprising at least one depressible button using the 3D touch screen display such that the depressible button appears to be to the user in front of the surface of the 3D touch screen display to thereby reduce a pressure made by a user on the surface of the 3D touch screen display when the user interacts with the depressible button.

2. The method as claimed in claim 1, wherein the event comprises one of providing a key character to an application, launching a program, executing a file, launching a portion of an application and accessing a weblink.

3. The method as claimed claim 1, wherein the depressible button comprises at least one of a letter, a number, a character, a symbol, a picture, an animation and a video.

4. A computing device, the computing device comprising:
a 3D touch screen display;
a central processing unit;
a memory comprising a program, wherein the program is stored in the memory and configured to be executed by the central processing unit, the programs comprising:
instructions for detecting an event;
instructions for displaying the user interface, in response to the detection of the event, the displaying of the user interface comprising at least one depressible button using the 3D touch screen display such that the depressible button appears to be to the user in front of the surface of the 3D touch screen display to thereby reduce a pressure made by a user on the surface of the 3D touch screen display when the user interacts with the depressible button.

5. A computer-readable storage medium storing computer-executable instructions which, when executed, cause a computing device comprising a 3D touch screen display to perform a method for improving an interaction with a user interface, the method comprising:
detecting an event;
in response to the detection of the event, displaying the user interface comprising at least one depressible button using the 3D touch screen display such that the depressible button appears to be to the user in front of the surface of the 3D touch screen display to thereby reduce a pressure made by a user on the surface of the 3D touch screen display when the user interacts with the depressible button.
